(19) United States
(12) Patent Application Publication
(10) Pub. No.: US 2015/0292882 A1
(43) Pub. Date: Oct. 15, 2015

(54) SYSTEM FOR MEASURING ORTHOGONALITY OF A STAGE AND METHOD FOR POSITIONING STAGE HOME USING SAME

(71) Applicant: SOONHAN ENGINEERING CORP., Seongnam City (KR)

(72) Inventor: Jong Kyu Seo, Seongnam City (KR)

(21) Appl. No.: 14/683,943

(22) Filed: Apr. 10, 2015

(30) Foreign Application Priority Data
Apr. 10, 2014 (KR) 10-2014-0042851

(51) Int. Cl. G01B 21/22; G01B 21/16; G01D 5/00

(52) U.S. Cl. CPC G01B 21/22; G01D 5/00; G01B 21/16

(57) ABSTRACT

A system for measuring the orthogonality of a stage includes: a first and a second X-axial drive feedback device respectively mounted in a pair of guides respectively arranged in both sides of the stage for measuring and providing a displacement for changing the X-axial position of the stage; a Y-axial drive feedback device mounted in a crossbeam of the stage for measuring and providing a displacement for changing the Y-axial position of the stage; a first and a second X-axial absolute feedback device each mounted at a position in both ends of the crossbeam where the crossbeam intersects with the pair of guides for measuring and providing the position of each of the axes constituting the orthogonality of the stage; and a control unit for controlling the displacement of the stage and detecting a variation of the orthogonality of the stage according to a feedback received from the first and the second X-axial drive feedback devices, the Y-axial drive feedback device, and the first and the second X-axial absolute feedback devices.

### CROSS-REFERENCE TO RELATED APPLICATIONS

The present application claims priority to Application No. 10-2014-0042851, filed in the Republic of Korea on Apr. 10, 2014, which is expressly incorporated herein in its entirety by reference thereto.

### FIELD OF THE INVENTION

The present invention relates to a system for measuring the orthogonality of a stage and to a method for positioning a stage home using the same. More particularly, the present invention relates to a system for measuring the orthogonality of a stage and detecting a variation of the orthogonality through measuring in real time each of the axes constituting the orthogonality of the stage by an incremental feedback device for driving the stage and an absolute feedback device for measuring the position of each of the axes constituting the orthogonality of the stage, and to a method for quickly and accurately positioning the stage home by using the system.

### BACKGROUND INFORMATION

FIG. 1 shows the structure of a stage for illustrating the elements constituting the orthogonality of the stage.

Referring to FIG. 1, a gantry structure type stage includes two linear motors 11, 12 arranged in parallel with each other in the direction of a moving axis, two linear encoders 21, 22 for respectively detecting the positions of the linear motors 11, 12, two guides 31, 32 for respectively supporting and guiding the linear motors 11, 12, and a crossbeam 40 for mechanically connecting the two linear motors 11, 12. Here, the guides 31, 32 positioned on both sides constitute an X-axis, and the crossbeam 40 constitutes a Y-axis, where the X-axis and Y-axis should form a right angle with each other.

However, while operating the gantry structure type stage, a problem occurring in the rigidity of the mechanical fastening or an external influence may cause a variation in the orthogonality of the X-axis and Y-axis, which variation serves as an error significantly affecting the result of a production process or apparatus using the gantry structure type stage.

Conventionally, the measurement of an error in the orthogonality of the stage has been achieved by calculating the difference between the two values that are obtained by measuring the length of a diagonal by two laser interferometers. However, this method requires much time and cost, and may cause installation and measurement errors of the laser interferometer depending on the worker. Moreover, it is difficult to employ this method while operating the stage.

Meanwhile, the accuracy and speed of positioning the stage home are important considerations for precisely controlling the position of a production apparatus including the stage and improving the production speed.

However, when positioning a stage home conventionally, the home sensor or index may cause a lowering of the precision of the positioning. In this case, the speed of moving the stage home must be lowered, thus suffering a drawback of increasing the time for positioning the stage home.

### SUMMARY

Example embodiments of the present invention provide a system for measuring in real time the orthogonality of the stage so as to detect a problem during the operation of a production apparatus including the stage, and furthermore for quickly and accurately positioning the stage home.

According to an example embodiment of the present invention, a system for measuring the orthogonality of a stage includes: a first and a second X-axial drive feedback device respectively mounted in a pair of guides respectively arranged in both sides of the stage for measuring and providing a displacement for changing the X-axial position of the stage; a Y-axial drive feedback device mounted in a crossbeam of the stage for measuring and providing a displacement for changing the Y-axial position of the stage; a first and a second X-axial absolute feedback device each mounted at a position in both ends of the crossbeam where the crossbeam intersects with the pair of guides for measuring and providing the position of each of the axes constituting the orthogonality of the stage; and a control unit for controlling the displacement of the stage and detecting a variation of the orthogonality of the stage according to a feedback received from the first and the second X-axial drive feedback device, the Y-axial drive feedback device, and the first and the second X-axial absolute feedback device.

According to an example embodiment of the present invention, a method for positioning a stage home by a system for measuring the orthogonality of the stage includes: moving the stage up to a limit sensor provided at the ends of guides on both sides of the stage by using the incremental feedback device; and moving the stage up to a position provided with a home sensor of the stage by using the absolute feedback device.

Thus, provided are a system for measuring the orthogonality of a stage and detecting a variation of the orthogonality through measuring in real time each of the axes constituting the orthogonality of the stage by an incremental feedback device for driving the stage and an absolute feedback device for measuring the position of each of the axes constituting the orthogonality of the stage, and a method for positioning the stage home by using the system.

Further features and aspects of example embodiments of the present invention are described in more detail below with reference to the appended Figures.

### BRIEF DESCRIPTION OF THE DRAWINGS

FIG. 1 shows the structure of a stage for illustrating the elements constituting the orthogonality of the stage.

FIGS. 2 and 3 illustrate the structure of a system for measuring the orthogonality of a stage according to an example embodiment of the present invention.

FIG. 4 illustrates a conventional methodology for positioning a stage home by an incremental feedback device.

FIG. 5 illustrates a methodology for positioning a stage home by an incremental feedback device and an absolute feedback device according to an example embodiment of the present invention.

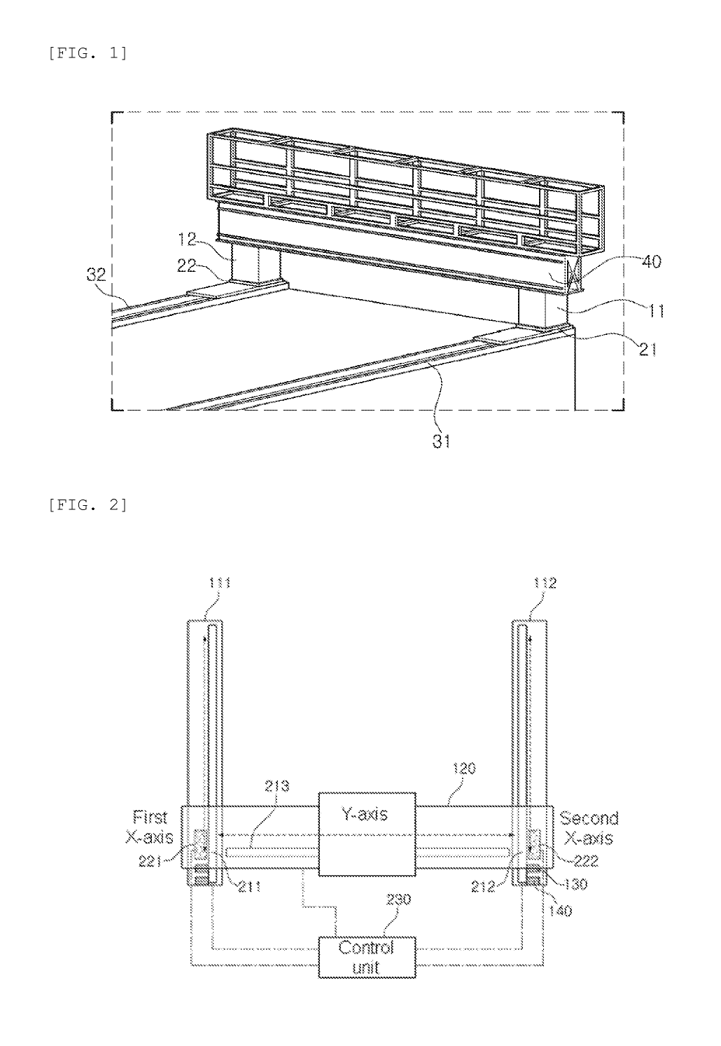

### DETAILED DESCRIPTION

Hereinafter will be more specifically described example embodiments of the present invention with reference to the attached drawings. The same reference numerals are used for the parts with a similar function throughout the attached drawings.

In addition, the expression that a part is connected to another part in the specification means a direct connection between them and/or an indirect connection via another element between them.

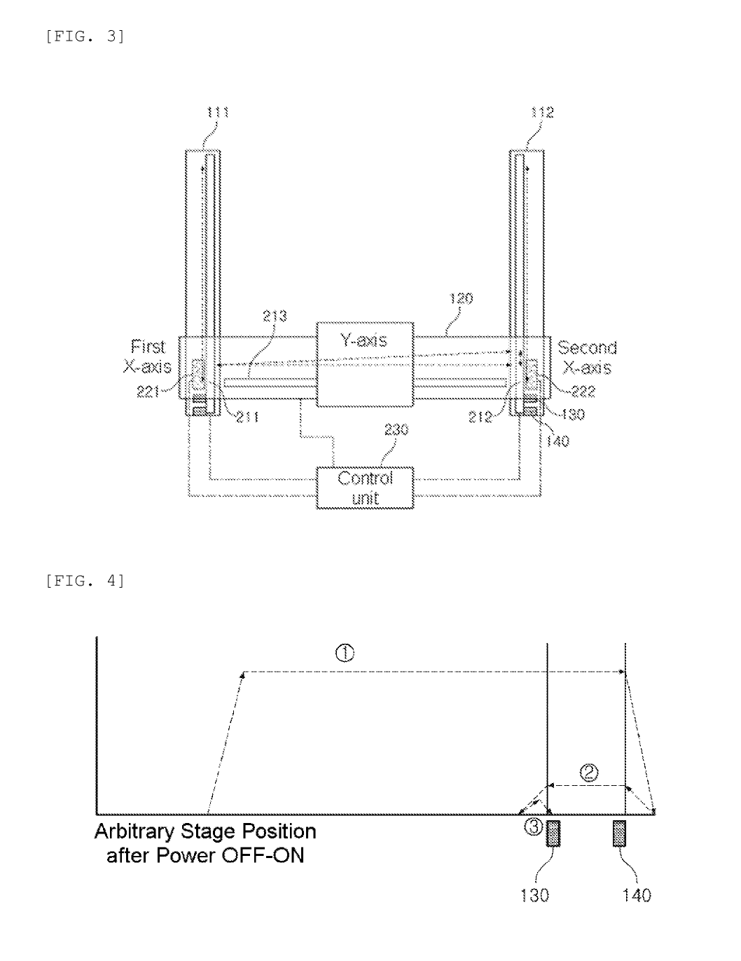

FIGS. 2 and 3 show the structure of a system for measuring the orthogonality of a stage according to an example embodiment of the present invention, wherein FIG. 2 shows the initially assembled state of the stage, and FIG. 3 the state of the orthogonality varied during operation of the stage.

Referring to FIG. 2, a system 200 for measuring the orthogonality of a stage includes a first and a second X-axial drive feedback device 211, 212, a Y-axial drive feedback device 213, a first and a second X-axial absolute feedback device 221, 222, and a control unit 230.

The first and the second X-axial drive feedback devices 211, 212 are mounted in respective guides 111, 112 arranged on both sides of the stage to change the X-axial position of the stage, and the Y-axial feedback device 213 is mounted in a crossbeam 120 to change the Y-axial position of the stage, which feedback devices may include an incremental encoder.

The incremental encoder of the first and the second X-axial drive feedback devices 211, 212 and the Y-axial feedback device 213 can only provide a positional variation, namely, the amount of displacement from the initial position, but not the absolute value of the present position. Hence, if the control unit 230 or the amplifier receiving feedback from the incremental encoder has been turned off, the value of the present position cannot be obtained even if it is turned on again.

The first and the second X-axial absolute feedback devices 221, 222 are respectively mounted at the positions in both ends of the crossbeam 120 where the crossbeam 120 intersects with the guides 111, 112, to measure the position of each of the axes constituting the orthogonality of the stage, which feedback devices may include an absolute encoder.

The absolute encoder constituting the first and the second X-axial feedback devices 221, 222 may provide the absolute value of the present position, and therefore, even if the control unit 230 or the amplifier receiving feedback from the absolute encoder is turned on again after having been turned off, the absolute value of the present position may be obtained.

The control unit 230 controls the displacement of the stage and detects a variation of the orthogonality of the stage according to a feedback received from the first and the second X-axial drive feedback devices 211, 212, the Y-axial drive feedback device 213, and the first and the second X-axial absolute feedback devices 221, 222, which control unit includes a microprocessor for calculating and controlling.

The control unit 230 may provide the absolute value of the present position of the stage even if the power is turned off during operation of the stage, because it receives feedback from both incremental encoder and absolute encoder. Hence, the control unit 230 may calculate in real time a variation of the orthogonality of the stage based on the orthogonality measured initially at the time of assembling the stage as shown in FIG. 2 and the varied orthogonality measured during operation of the stage as shown in FIG. 3.

In addition, the control unit 230 may use a variation of the orthogonality for diagnosing, monitoring, and analyzing problems of the system, or provide it to an external instrument to this end.

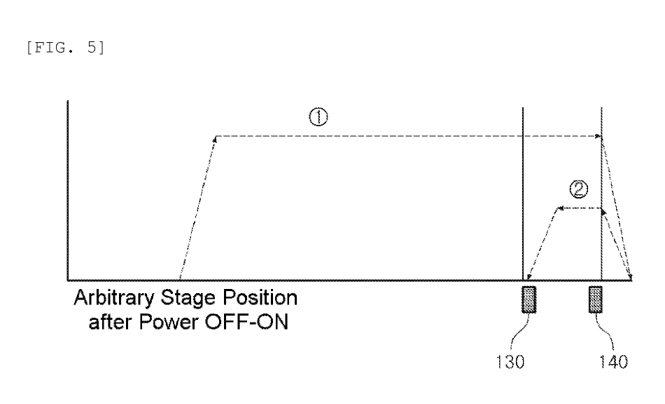

FIG. 4 illustrates a conventional methodology for positioning a stage home by an incremental feedback device.

Referring to FIG. 4, if positioning a stage home only by a conventional incremental feedback device, \textcircled{1} the stage firstly is moved up to a limit sensor 140 installed in one end of the guide 111, 112 at both sides of the stage, \textcircled{2} and then in the opposite direction in order to find a home sensor 130. In this case it should be moved with a low speed for a precise positioning, and should be moved to an additional distance after detecting the home sensor in order to reduce the speed. \textcircled{3} After stopping with the speed reduction, it should be moved again up to the detected home sensor, and therefore it takes a long time along with a degradation of precision.

FIG. 5 illustrates a method for positioning a stage home by an incremental feedback device and an absolute feedback device according to an example embodiment of the present invention.

Referring to FIG. 5, if positioning a stage home by a system for measuring the orthogonality of the stage according to an example embodiment of the present invention, \textcircled{1} the stage firstly is moved up to the limit sensor 140 by the first and the second X-axial drive feedback devices 211, 212, \textcircled{2} and then quickly to the home position by the first and the second X-axial absolute feedback devices 221, 222. Thus, the precision and speed of positioning the stage home is improved, thereby enhancing the precision and productivity of the system.

Example embodiments of the present invention may precisely detect in real time a variation of the orthogonality of the stage during operation of the stage so as to discover in advance an error of the stage and to provide data for correcting the error.

In addition, the absolute value of the home position of the stage may be measured so as to improve the speed, precision, and stability of positioning the stage home.

Also, both incremental feedback devices and absolute feedback devices are employed so as to use the absolute feedback device of higher cost and lower precision least, thereby decreasing the production cost and improving the precision of controlling.

It should be understood that present invention is not limited by the above-described example embodiments and the attached drawings. Instead, substitutions, modifications, and/or alterations may be made without departing from the spirit and scope hereof.

### LIST OF REFERENCE NUMERALS

11, 12: linear motor
21, 22: linear encoder
31, 32: guide
40: crossbeam
111, 112: guide
120: crossbeam
130: home sensor
140: limit sensor
200: system for measuring orthogonality of stage
211, 212: X-axial drive feedback device
213: Y-axial drive feedback device
221, 222: X-axial absolute feedback device
230: control unit

What is claimed is:

1. A system for measuring orthogonality of a stage, comprising:
a first and a second X-axial drive feedback device respectively mounted in a pair of guides respectively arranged on both sides of the stage adapted to measure and provide a displacement to change an X-axial position of the stage;
a Y-axial drive feedback device mounted in a crossbeam of the stage adapted to measure and provide a displacement to change a Y-axial position of the stage;
a first and a second X-axial absolute feedback device each mounted at a position on both ends of the crossbeam where the crossbeam intersects with the pair of guides adapted to measure and provide the position of each of the axes representing the orthogonality of the stage; and
a control unit adapted to control displacement of the stage and to detect a variation of the orthogonality of the stage according to feedback received from the first and the second X-axial drive feedback devices, the Y-axial drive feedback device, and the first and the second X-axial absolute feedback devices.

2. The system according to claim 1, wherein the first and the second X-axial drive feedback devices include an incremental encoder.

3. The system according to claim 1, wherein the first and the second X-axial absolute value feedback devices include an absolute encoder.

4. The system according to claim 1, wherein the control unit is adapted to detect a variation of the orthogonality of the stage in real time based on the orthogonality measured at a time of initial assembly of the stage and a changed orthogonality measured during operation of the stage.

5. A method for positioning a stage home by a system including an incremental feedback device and an absolute feedback device for measuring orthogonality of the stage, comprising:
moving the stage up to a limit sensor provided at ends of guides on both sides of the stage by using the incremental feedback device; and
moving the stage up to a position provided with a home sensor of the stage by using the absolute feedback device.

6. The method according to claim 5, wherein the system is arranged according to claim 1.
